(19) United States
(12) Patent Application Publication
(10) Pub. No.: US 2026/0244546 A1
(43) Pub. Date: Aug. 20, 2026

(54) FAULT TIMING CONTROL SYSTEM AND FAULT TIMING CONTROL METHOD

(71) Applicant: Hitachi, Ltd., Tokyo (JP)

(72) Inventors: Hitoshi YABUSAKI, Tokyo (JP); Yosuke HIMURA, Tokyo (JP)

(21) Appl. No.: 19/304,939

(22) Filed: Aug. 20, 2025

(30) Foreign Application Priority Data
Feb. 17, 2025 (JP) 2025-023463

(51) Int. Cl. G06F 11/26; G06F 11/263

(52) U.S. Cl. CPC G06F 11/261; G06F 11/263

(57) ABSTRACT

A computer in the test execution environment reads a state indicating a status or a condition of the system from trace information at the time of a fault occurrence, and calculates a waiting time for differently timing a pseudo fault according to the read state, generates the pseudo fault based on a send time of a request time for generating the pseudo fault and the calculated waiting time.

### CROSS-REFERENCE TO RELATED APPLICATION

The present application claims priority from Japanese application JP2025-023463, filed on Feb. 17, 2025, the content of which is hereby incorporated by reference into this application.

### BACKGROUND OF THE INVENTION

### 1. Field of the Invention

The present invention relates to a fault timing control system and a fault timing control method.

### 2. Description of the Related Art

The importance of continuous security of IT systems is increasing. It is necessary to update the infrastructure sequentially in order to respond to vulnerabilities in the infrastructure software that are discovered continuously and unexpectedly. However, system testing for IT systems, which requires a large amount of man-hours, cannot always be handled manually, and automation is necessary.

For example, in a public cloud environment where IT systems are built for multiple tenants, the influence of other tenants cannot be eliminated. One example is the impact of a change in the volume of transactions to one tenant's IT system on another tenant's IT system. As a result, Non-Deterministic Bugs, which depend on specific timing or system status and do not produce the same results each time the same operation is performed, and Flaky Tests, which fail rarely, are more likely to occur than in an on-premise environment. Such non-reproducible faults are difficult to verify, with the only option being to wait until they recur, etc.

For example, US2020-0034284A1 is a technology that attempts to solve such problems. In US2020-0034284A1, live migration at multiple time points (multipoints) is combined with a CPU lock step to consistently reproduce bugs that are difficult to reproduce. In particular, it reproduces bugs that occur in multi-threaded race conditions and containerized systems.

### SUMMARY OF THE INVENTION

US2020-0034284A1 enables analysis of bugs, but does not solve problems caused by timing of external factors such as faults. For example, in a fault test that sends test requests and injects simulated faults to an IT system consisting of multiple components such as an application server and a data store, it is not possible to cause a simulated fault at the appropriate timing and state for a series of processing processes that are carried out over a predetermined time span (e.g., on the order of milliseconds to tens of milliseconds) and reproduce the problem.

An object of the invention is to provide a technology that can cause a pseudo fault at the appropriate timing and state and reproduce the fault.

A fault timing control system including a test execution environment according to the invention, which is executed by a computer including a processor and a memory, for performing a test that simulates a fault occurred in a production environment of a system, the computer in the test execution environment reads a state indicating a status or a condition of the system from trace information at the time of a fault occurrence, and calculates a waiting time for differently timing a pseudo fault according to the read state,
generates the pseudo fault based on a send time of a request time for generating the pseudo fault and the calculated waiting time.

According to the present invention, it is possible to cause a pseudo fault at the appropriate timing and state and reproduce the fault.

### BRIEF DESCRIPTION OF THE DRAWINGS

FIG. 1 is an example of the configuration of an applicable system;

FIG. 2 is a diagram illustrating a schematic example of a computer;

FIG. 3 is a functional diagram of the test execution system shown in FIG. 1;

FIG. 4 is an example of a sequence of events when a fault occurs in a production environment;

FIG. 5 is an example of the sequence of tests normally performed in a verification environment when the fault shown in FIG. 4 occurs;

FIG. 6 is an example of a sequence for testing with delay loading in the verification environment when the fault shown in FIG. 4 occurs;

FIG. 7A is an example of a test orchestration process shown in FIG. 6;

FIG. 7B is an example of the test orchestration process shown in FIG. 6;

FIG. 8 is an example of a fault history table;

FIG. 9 is an example of a pseudo fault history table;

FIG. 10 is an example of trace information;

FIG. 11 is an example of trace information for one request, which is the source of the trace information shown in FIG. 10;

FIG. 12 is an example of one request pattern in which similar trace combinations are eliminated at each step number;

FIG. 13 is an example of a state table;

FIG. 14 is an example of a state history table at the time of a pseudo fault.

### DETAILED DESCRIPTION OF THE PREFERRED EMBODIMENTS

Hereinafter, an embodiment of the invention will be described with reference to the drawings. The following description and drawings are illustrative for describing the invention, and are suitably omitted and simplified for the clarification of the description. The invention can also be implemented in various other forms. Unless specifically limited, each constituent may be singular or plural. The position, the size, the shape, the range, and the like of each constituent illustrated in the drawings may not represent the actual position, size, shape, range, and the like, in order to facilitate the understanding of the invention. Accordingly, the invention is not necessarily limited to the position, the size, the shape, the range, and the like disclosed in the drawings.

In the following description, various information pieces may be described by expressions such as a “database”, a “table”, and a “list”, but various information pieces may be expressed by other data structures. An “XX table”, an “XX list”, and the like may be referred to as “XX information” to indicate independence on the data structure. In the case of using expressions such as “identification information”, an “identifier”, a “name”, an “ID”, and a “number” when describing identification information, such expressions can be replaced with each other.

In a case where there are a plurality of constituents having the same or similar functions, the constituents will be described by applying different suffixes to the same reference numerals. However, in a case where it is not necessary to distinguish the plurality of constituents, the constituents may be described by omitting the suffixes.

In addition, in the following description, processing performed by executing a program may be described, but the program is executed by a processor (for example, a CPU or a graphics processing unit (GPU)) to perform predetermined processing while suitably using memory resources (for example, a memory) and/or an interface device (for example, a communication port), and thus, the subject of the processing may be the processor. Similarly, the subject of the processing performed by executing the program may be a controller, a device, a system, a computer, or a node including the processor. The subject of the processing performed by executing the program may be an arithmetic unit, and may include a dedicated circuit performing specific processing (for example, a field programmable gate array (FPGA) and an application specific integrated circuit (ASIC)).

The program may be installed in a device such as a computer from a program source. The program source, for example, may be a program distribution server or a computer-readable storage medium. In a case where the program source is the program distribution server, the program distribution server may include a processor and memory resources storing a distribution target program, and the processor of the program distribution server may distribute the distribution target program to another computer. In addition, in the following description, two or more programs may be attained as one program, or one program may be attained as two or more programs.

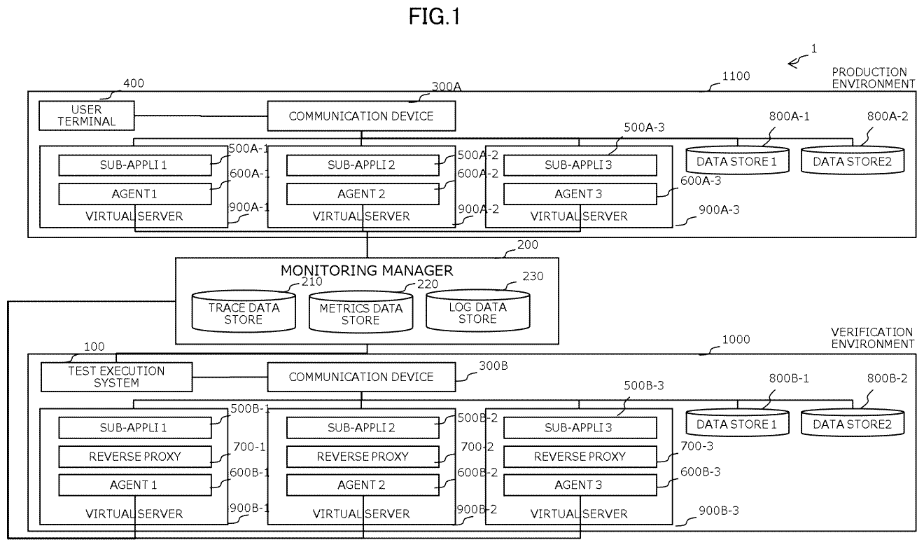

FIG. 1 shows an example of the configuration of an applicable system 1. The applicable system 1 includes a production environment 1100, which is applied as a test target of a test execution system 100 that functions as a fault timing control system, and a verification environment 1000 for reproducing faults that occur in the production environment 1100, which are communicatively connected via a monitoring manager 200.

The verification environment 1000 constitutes a system environment for reproducing faults that occurred in the production environment 1100. As shown in FIG. 1, the verification environment 1000 comprises the test execution system 100, a communication device 300b, one or more data stores 800b (in this example, data stores 800b-1 and 800b-2), and one or more virtual servers 900b (in this example, the virtual servers 900b-1, 900b-2, 900b-3).

The test execution system 100 is a system for test orchestration to reproduce faults that occur in the production environment 1100 by causing pseudo faults at appropriate times and states. A state is a status or a condition of the system at a particular point in time (e.g., when a fault occurred). The specific configuration of the test execution system 100 is described below.

The communication device 300b is, for example, an L3 router, which controls communication between the data store 800b and the virtual server 900b and the test execution system 100.

The data store 800b is, for example, a Blob store or RDB, which simulates the data store 800b in the production environment 1100.

The virtual server 900b is, for example, a server for running VMs and simulates the virtual server 900a in the production environment 1100.

In addition, the virtual server 900b comprises sub-applications 500b (in this example, sub-applications 500b-1, 500b-2, and 500b-3), monitoring agents 600b (in this example, monitoring agents 600b-1, 600b-2, 600b-3), and reverse proxies 700b (in this example, reverse proxies 700b-1, 700b-2, 700b-3).

The sub-application 500b is, for example, a web application, and is an application that simulates a sub-application 500a of a virtual server 900a in the production environment 1100.

The monitoring agent 600b is, for example, a VM container and is an agent that simulates the monitoring agent 600a of the virtual server 900a in the production environment 1100.

The reverse proxy 700 is a server that performs load balancing at the layer, and in this example, it serves to delay requests for testing in order to cause faults at the targeted status timing and state.

The production environment 1100 is the system environment applied as the test target for the tests performed by the test execution system 100. As shown in FIG. 1, the production environment 1100 comprises a user terminal 400, a communication device 300a, one or more data stores 800a (in this example, data stores 800a-1 and 800a-2), one or more virtual servers 900a (in this example, virtual servers 900a-1, 900a-2, 900a-3).

The user terminal 400 is, for example, a terminal such as a PC or smartphone operated by a user who uses the production environment 1100.

The communication device 300a is, for example, an L3 router, which controls communication between the data store 800a and the virtual server 900a and the user terminal 400.

The data store 800a is, for example, a Blob store or RDB, which holds data necessary for services provided to users by one or more tenants.

The virtual server 900a, for example, is a server for running VMs and functioning services provided to users by one or more tenants.

The virtual server 900a also includes sub-applications 500a (in this example, sub-applications 500a-1, 500a-2, and 500a-3) and monitoring agents 600a (in this example, monitoring agents 600a-1, 600a-2, 600a-3).

The sub-application 500a is, for example, a web application, and the monitoring agent 600a is, for example, a VM container.

The monitoring manager 200 is a server that monitors both the production environment 1100 and the verification environment 1000, and collects traces, metrics, and logs for each of these environments and stores them in a data store. In this example, the monitoring manager 200 holds the collected traces, metrics, and logs in a trace data store 210, a metrics data store 220, and a log data store 230, respectively. Traces, for example, are information collected to check the flow of processing from processing request to response in the production environment 1100. Metrics are information collected to grasp the internal status of the system in the production environment 1100, for example, CPU utilization and disk capacity. Logs are information collected on the occurrence situation and operation situation of events handled by the system in the production environment 1100, including information about faults. In this example, the trace data store 210, the metrics data store 220, and the log data store 230 are held separately, but they may be managed and stored together in one.

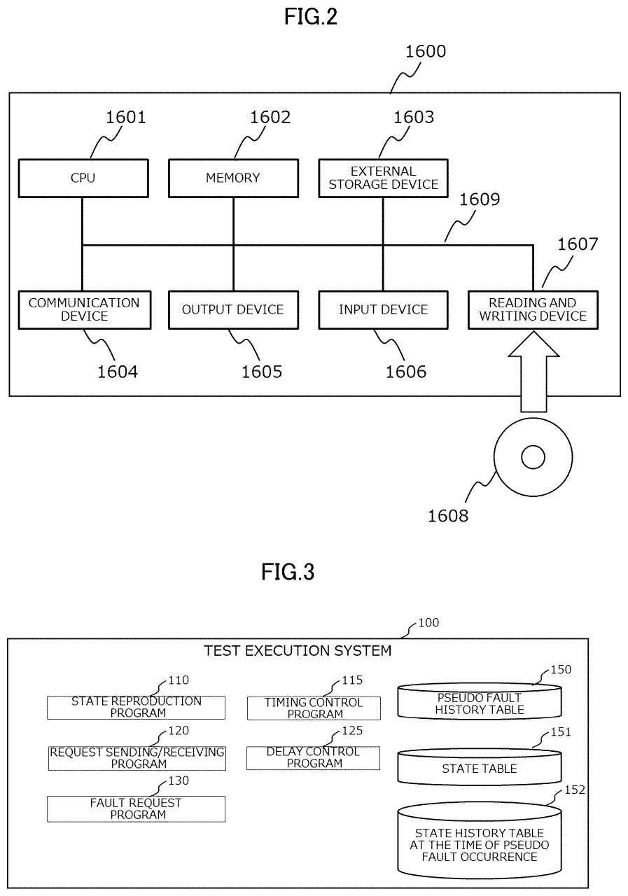

The servers, the data stores, the terminals, and other components of the production environment 1100, the verification environment 1000, and the monitoring manager 200 may be configured as hardware by a general computer. The computer, for example, can be attained by a general computer 1600 including an external storage device 1603 such as a CPU 1601, a memory 1602, a hard disk drive (HDD), a reading and writing device 1607 reading and writing information with respect to a storage medium 1608 having portability, such as a compact disk (CD) and a USB memory, an input device 1606 such as a keyboard, a mouse, and a microphone, an output device 1605 such as a display and a speaker, a communication device 1604 such as a network interface card (NIC) for connection with a communication network, an internal communication line (referred to as a system bus) 1609 such as a system bus linking the above, as illustrated in FIG. 2 (a computer schematic view).

In addition, various data pieces, which are stored in the monitoring manager 200 or used for processing, can be attained by the CPU 1601 reading out the data from the memory 1602 or the external storage device 1603 to use the data. In addition, each function unit of the monitoring manager 200 can be attained by the CPU 1601 loading a predetermined program stored in the external storage device 1603 on the memory 1602 to execute the program.

The predetermined program described above may be stored (downloaded) in an external storage device 1603 from the storage medium 1608 via the reading and writing device 1607 or from a network via the communication device 1604, and then, loaded on the memory 1602, and executed by the CPU 1601. In addition, the predetermined program may be directly loaded on the memory 1602 from the storage medium 1608 via the reading and writing device 1607 or from a network via the communication device 1604, and executed by the CPU 1601.

FIG. 3 shows the functional configuration of the test execution system 100 shown in FIG. 1. As mentioned above, the test execution system 100 may be configured by a general computer as hardware. As shown in FIG. 3, the test execution system 100 includes a state reproduction program 110, a timing control program 115, a request sending/receiving program 120, a delay control program 125, a fault request program 130, a pseudo fault history table 150, a state table 151, a state history table 152 at the time of a pseudo fault occurrence. The processing performed by each program and the data stored by each table are described below.

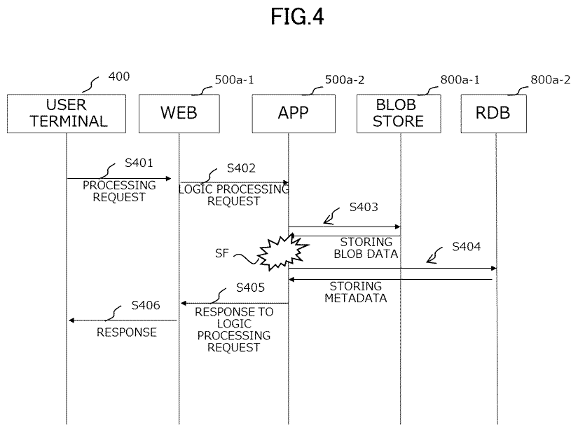

FIG. 4 shows an example of a sequence of events when a fault occurs in the production environment. As shown in FIG. 4, when a fault occurs in the production environment 1100, the user terminal 400 sends a processing request to sub-application 500a-1(Web) that is a Web application (S401), and then the sub-application 500a-1 sends a logic processing request to another sub-application 500a-2(App) that is called from the Web application (S402).

The other sub-application 500a-2 performs processing in accordance with the above logic processing request, and after storing the blob data in the data store 800a-1 that is the destination for the blob data (S403), stores the metadata in the data store 800a-1 that is the destination for the metadata (S404). At this time, a response to the logic processing request may be sent with a delay due to some fault SF in the other sub-application 500a-2 (S405), and a response to the processing request may be sent to sub-application 500a-1 (S 406). In the production environment 1100, for example, applications of various tenants are running and transactions are changing from moment to moment, but when trying to reproduce some fault described above, under such situations, the time between the processing request of S401 and the response of S406, from a few milliseconds to several tens of milliseconds, is the time when it will be necessary to reproduce the fault.

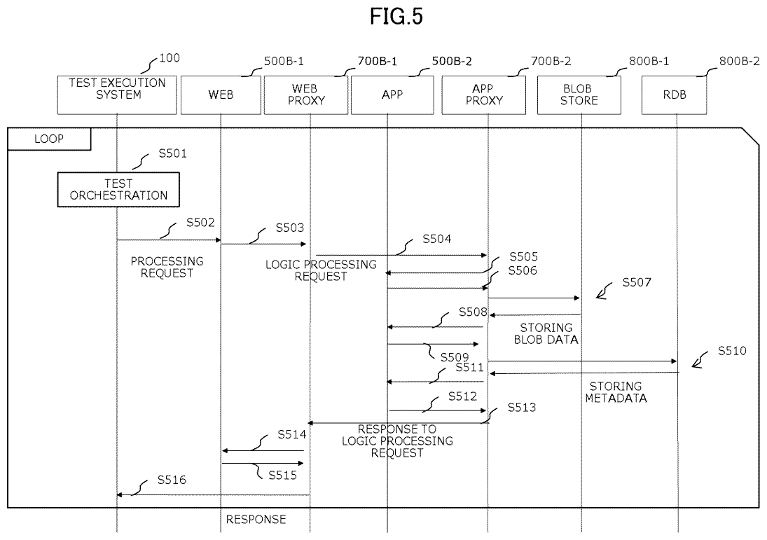

FIG. 5 shows an example of the sequence of tests normally performed in a verification environment when the fault shown in FIG. 4 occurs. As shown in FIG. 5, in the verification environment 1000, for example, the test execution system 100 executes test orchestration according to a predetermined test plan in order to perform tests for some fault SF shown in FIG. 4 (S501). The test execution system 100 sends a processing request including a request for testing according to the above test plan to the sub-application 500b-1 (Web), which is a Web application (S502), and further, the sub-application 500b-1 sends the processing request to the reverse proxy 700b-1 of the Web application (S503).

The reverse proxy 700b-1 sends a logic processing request for the other sub-application 500b-2 (App) called from the Web application to the reverse proxy 700b-2 of the other sub-application 500b-2 called from the Web application (S504). The reverse proxy 700b-2 sends the above logic processing request received in S504 to the other sub-application 500b-2 (S505).

The other sub-application 500b-2 performs processing related to the above test according to the above logic processing request and sends the results to the reverse proxy 700b-2 (S506). The reverse proxy 700b-2, on behalf of the other sub-application 500b-2, stores the blob data in the data store 800b-1, where the blob data will be stored (S507), and then sends the results to the other sub-application 500b-2 (S508).

The other sub-application 500b-2 sends a metadata storage request to the reverse proxy 700b-2 (S509), and the reverse proxy 700b-2 stores the metadata in the data store 800b-1 that is to store the metadata (S510). The reverse proxy 700b-2 notifies the other sub-application 500b-2 that the blob data and the metadata storage is complete (S511), and the other sub-application 500b-2 sends the processing results of the processing performed according to the above logic processing request to the reverse proxy 700b-2 (S512).

The reverse proxy 700b-2 sends a response to the above logic processing request received in S505 to the reverse proxy 700b-1 (S513). The reverse proxy 700b-1 sends the above response received from the reverse proxy 700b-2 to the sub-application 500b-1 (S514), the sub-application 500b-1 sends a response to the processing request to the reverse proxy 700b-1 (S515). The reverse proxy 700b-1 sends the above response received from the sub-application 500b-1 to the test execution system 100 (S516). In the verification environment 1000, such processes up to S502~S516 are repeatedly executed according to the test plan of the test orchestration created in S501, for example, which combines various conditions to reproduce faults that occurred between a few milliseconds and tens of milliseconds.

However, if the production environment 1100 is, for example, a public cloud environment where IT systems are built for multiple tenants, the influence of other tenants cannot be eliminated, and faults that occur between a few milliseconds and a few dozen milliseconds cannot necessarily be reproduced with high accuracy. As already explained, a change in the volume of transactions for one tenant's IT system may have an impact on another tenant's IT system. Therefore, the method shown in FIG. 5 cannot reproduce faults by causing pseudo faults at the appropriate timing and state for a series of processing processes that take place within a predetermined time span (for example, on the order of milliseconds to tens of milliseconds) in a fault test in which test requests are sent and pseudo faults are injected. Therefore, in this example, we consider the case where a delay is added to the test in the verification environment 1000.

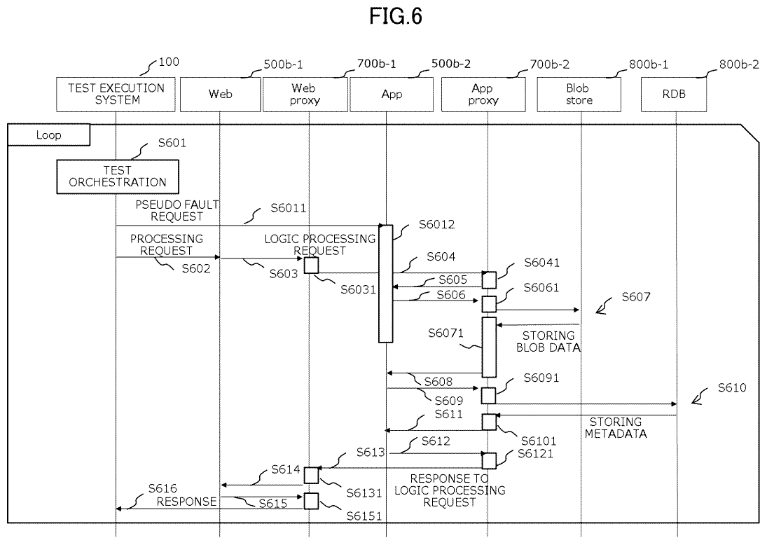

FIG. 6 shows an example of the sequence of testing after loading delays in the verification environment when the fault shown in FIG. 4 occurs. In FIG. 6, the flow of the procedure is the same as in FIG. 5, but when the proxy servers (the reverse proxies 700b-1 and 700b-2) and the application server (the other sub-application 500b-2) exchange data, there is a predetermined delay time defined in the test plan. This allows for accurate reproduction of faults that may occur in milliseconds.

FIG. 6 shows an example of the sequence of tests performed in the verification environment in this example when the fault shown in FIG. 4 occurs. In FIG. 6, as in FIG. 5, when the test orchestration is performed (S601), the test execution system 100 sends a pseudo fault request to the application server (the other sub-application 500b-2) where the fault occurred (S6011). At this time, the test execution system 100 refers to the pseudo fault history table 150 described later, and sets the time that will be the trigger for a simulated faults that was previously generated for the other sub-application 500b-2, which is stored in association with the fault type and fault location to be tested (here, the other sub-application 500b-2). The other sub-application 500b-2 obtains logs, traces, and metrics from the trigger time to the fault occurrence time (or response time) via the test execution system 100 (S6012).

Then, as in FIG. 5, the test execution system 100 sends the above processing request to sub-application 500b-1 (S602), and the sub-application 500b-1 sends the processing request to the reverse proxy 700b-1 of the Web application (S603).

After the reverse proxy 700b-1 counts (S6031) that the delay time of the predetermined time span (e.g., on the order of milli~tens of milliseconds) has passed, to the reverse proxy 700b-2, as in FIG. 5, sends a logic processing request to the other sub-application 500b-2 (S604). As in S6031, the reverse proxy 700b-2 sends the above logic processing request to the other sub-application 500b-2 (S605) after the delay time of the predetermined time span has passed (S6041).

The other sub-application 500b-2 performs processing related to the above test according to the above logic processing request and sends the results to the reverse proxy 700b-2 (S606). As in S6041, the reverse proxy 700b-2, after the delay time of the predetermined time span has passed (S6061), stores the blob data on behalf of the other sub-application 500b-2 in the data store 800b-1 (S607). Further, as in S6061, after the delay time of the predetermined time span has passed (S6071), the result is sent to the other sub-application 500b-2 (S608).

The other sub-application 500b-2 sends a request to the reverse proxy 700b-2 to store the metadata (S609), as in FIG. 5, and the reverse proxy 700b-2, as in S6071, sends a request to the reverse proxy 700b-2 to store the metadata after the delay time of the predetermined time span has passed (S6091), the metadata is stored in the data store 800b-1, which is the metadata storage destination (S610). As in S6091, the reverse proxy 700b-2 notifies the other sub-application 500b-2 that the blob data and metadata have been stored (S611) after the delay time of the predetermined time span has passed (S6101). Furthermore, the other sub-application 500b-2 sends the processing results of the processing performed according to the above logic processing request to the reverse proxy 700b-2 (S612).

As in S6101, the reverse proxy 700b-2 sends a response to the above logic processing request to the reverse proxy 700b-1 (S613) after the delay time of the predetermined time span has passed (S6121), as in FIG. 5. As in S6121, after the delay time of the predetermined time span has passed (S6131), the reverse proxy 700b-1 sends the above response received from the reverse proxy 700b-2 to the sub-application 500b-1 (S 614), the sub-application 500b-1 sends the response to the above processing request to the reverse proxy 700b-1 (S615). As in S6131, the reverse proxy 700b-1 sends the above response received from sub-application 500b-1 to the test execution system 100 (S616) after the delay time of the predetermined time span has passed (S6151). In this example, for each of the faulted application server (the other sub-application 500b-2) and the proxy server that exchanges data with the application server (the reverse proxy 700b-1, 700b-2), respectively, are repeatedly executed according to a test plan that combines various conditions to reproduce the fault that occurred between a few milliseconds and a few tens of milliseconds, with the predetermined delay time specified in the test plan.

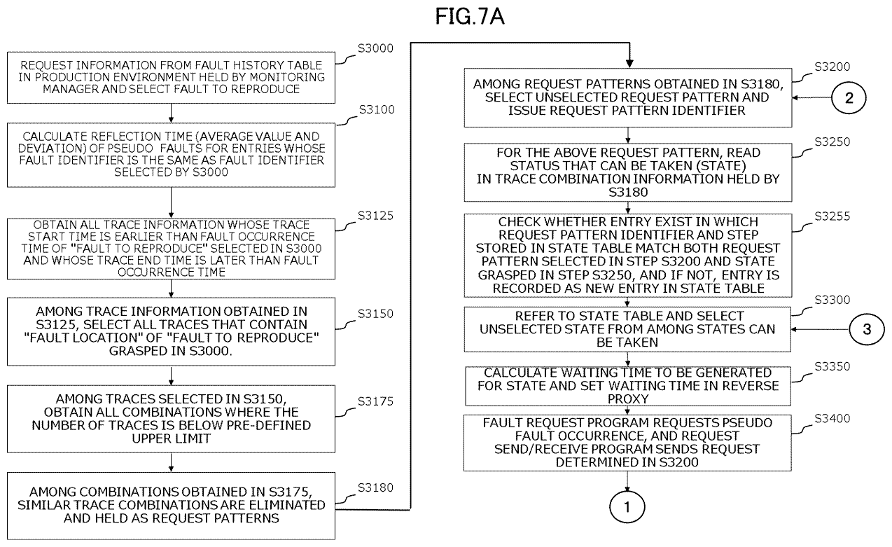

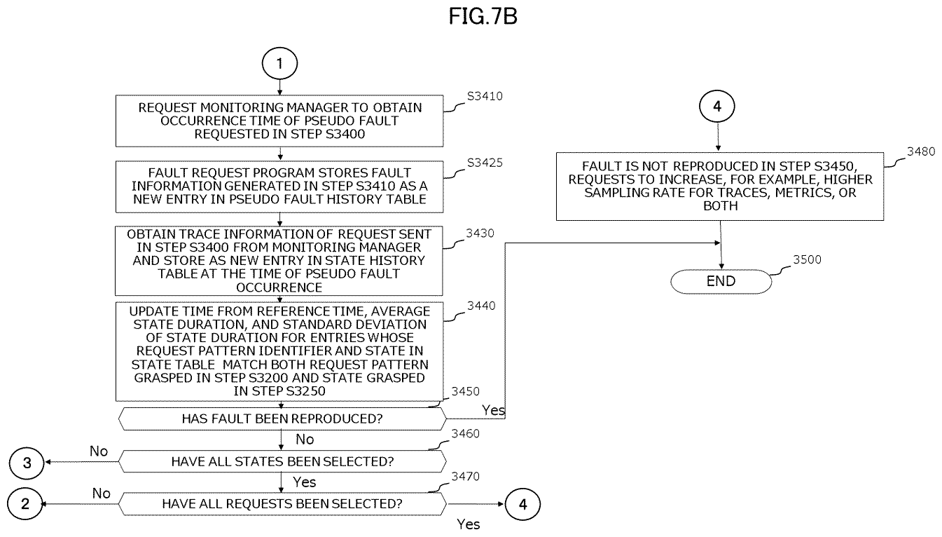

FIGS. 7A and 7B are flowcharts showing an example of the test orchestration process procedure shown in FIG. 6.

First, the state reproduction program 110 requests information from the fault history table 5000a in the production environment 1100 held by the monitoring manager 200 and selects the fault to reproduce (S3000). The fault history table 5000a is a table that accumulates faults that occurred in the production environment 1100.

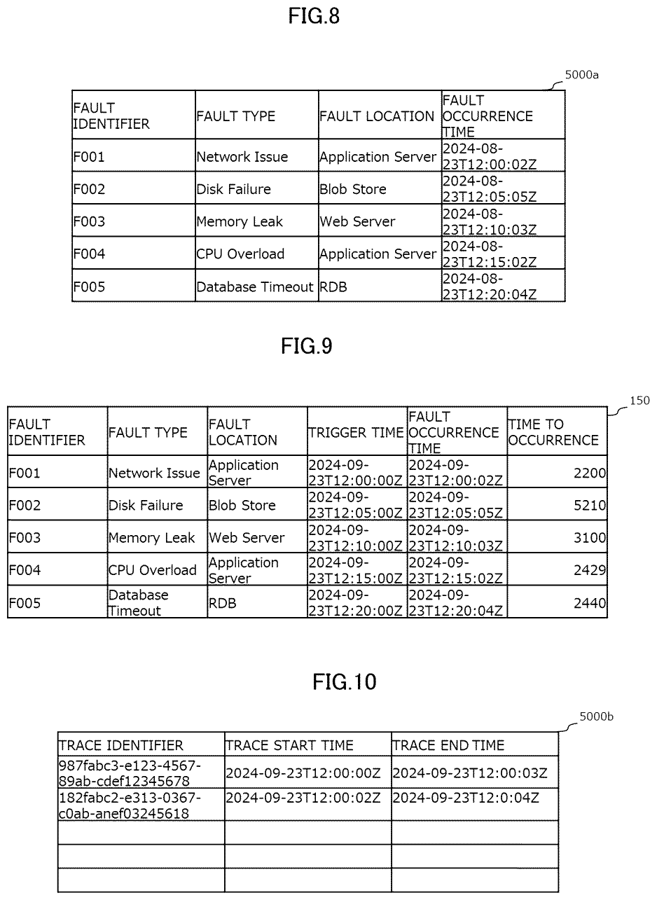

FIG. 8 shows an example of the fault history table 5000a. The fault history table 5000a is a table that stores information on faults that occurred in the production environment 1100 managed by the monitoring manager 200, and this system assumes that such information has been stored in advance. The items held by the fault history table 5000a are almost identical to those in the pseudo fault history table 150 described below, although columns related to “trigger time” and “time to occurrence” are not held. The monitoring manager 200 obtains and generates this information from traces, logs, metrics, etc. in the production environment 1100.

As shown in FIG. 8, the fault history table 5000a stores a fault identifier to identify the fault that occurred, a fault type to indicate the type of fault that occurred, a fault location to indicate the location of the fault that occurred, and a fault occurrence time to indicate the time when the fault occurred. In FIG. 8, for example, the fault identified by the fault identifier “F001” is a fault of the fault type “Network Issue” that occurred at the fault location “Application Server” and the fault occurred at the fault occurrence time “2024-08-23T12:00;02Z”.

Next, the timing control program 115 refers to the pseudo fault history table 150 and calculates a reflection time (e.g., mean value and deviation) of the pseudo fault for the entry whose fault identifier is a record containing the same fault identifier as the fault identifier selected in step S3000 (S3100). If there is no identical entry, a pre-defined value is used. The above reflection time is the time from the trigger time, which is the time when the pseudo fault request shown in FIG. 6 is sent, to the time when the pseudo fault occurs. The above reflection time may be the time from the send of the above pseudo fault request to the response. The time when the pseudo fault request was sent may be called a reference time. In this case, the start time of each test defined in the test orchestration becomes the reference time.

FIG. 9 shows an example of the pseudo fault history table 150. The pseudo fault history table 150 is a table that defines the conditions for simulating a fault that occurred in the production environment 1100 and reproducing the fault. As shown in FIG. 9, in addition to the items held by the fault history table 5000a described above, the pseudo fault history table 150 includes the columns related to the “trigger time” indicating the time when the pseudo fault request was sent to the fault location as a trigger to generate a pseudo fault, the “time to occurrence” that indicates the reflection time from the trigger time to the fault occurrence time, which is the time when the pseudo fault actually occurred.

In FIG. 9, for example, the fault identified by the fault identifier “F001” is a fault of the fault type “Network Issue” that occurred at the fault location “Application Server” and the fault will occur at the fault occurrence time “2024-08-23T12:00:02Z”. It also indicates that the above reflection time, which is the time from the trigger time “2024-09-23T12:00:00Z” to the time to the fault occurrence time, is “2200” seconds.

Next, the state reproduction program 110 obtains all trace information whose trace start time is earlier than the fault occurrence time and whose trace end time is later than the fault occurrence time (FIG. 8), corresponding to the fault identifier of the “fault to reproduce” selected in step S3000 (S3125).

FIG. 10 shows an example of the trace information 5000b. The trace information 5000b is a table that stores information about traces of fault that occurred in the production environment 1100 managed by the monitoring manager 200, and such information is assumed to have been accumulated in advance. The trace information 5000b is information that stores traces of requests actually made in the production environment 1100, and is stored in the trace data store 210 shown in FIG. 1. As shown in FIG. 10, the trace information 5000b is stored with a trace identifier to identify the trace information, a trace start time indicating the time when the trace was started, and a trace end time indicating the time when the trace was finished. In FIG. 10, the trace information for the production environment 1100 is shown as an example, but the same is stored for the verification environment 1000.

In FIG. 10, for example, the trace information identified by the trace identifier “987fabc3-e123-4567-89ab-cdef12345678” indicates that the information was traced from the trace start time “2024-09-23T12: 00:00Z” to the trace end time “2024-09-23T12:00:03Z”. These information can be obtained from the trace information (traces managed by the monitoring manager 200), which contains the contents and results of one or more processes performed in sequence in a single request.

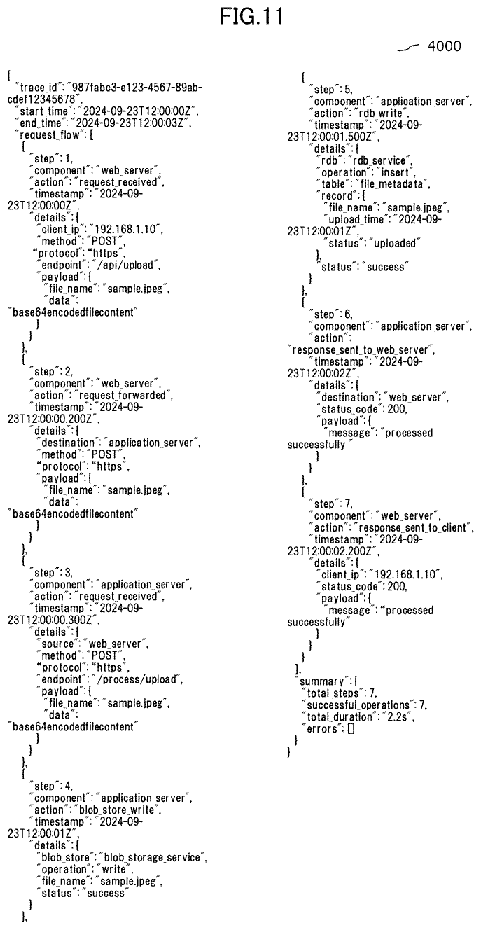

FIG. 11 shows an example of the trace information for one request, which is the source of the trace information shown in FIG. 10. As shown in FIG. 11, one request contains the trace information of processing in one or more steps. FIG. 11 shows that the trace identifier, the trace start time, and the trace end time of the trace information shown in FIG. 10 are information obtained from “trace_id,” “start_time,” and “end_time,” respectively. The trace information shown in FIG. 11 comprises the trace information of the process performed in each step from step1 to step7. In other words, when this request is executed, the trace information stores the states that indicate the results of the processing performed in the seven steps. In FIG. 11, for example, the result of the processing is described as a state in each of “payload,” “status,” “errors,” etc.

Returning to FIG. 7, the state reproduction program 110 selects all the traces in the trace information (FIG. 10 and FIG. 11) that contain the “fault location” (FIG. 8) corresponding to the fault identifier of the “fault to reproduce” selected in step S3000 (S3150) among the trace information (FIG. 10 and FIG. 11) obtained in step S3125.

The state reproduction program 110 obtains all combinations of the traces selected in step S3150 whose number of traces is less than the pre-defined limit (S3175). For example, among the trace information (FIG. 11) included in the above “fault location” (FIG. 8), the trace information with a step number of 7 or less is obtained. In this way, one or more combinations of trace information are obtained for each step number.

The state reproduction program 110 holds as a request pattern that eliminates similar trace combinations for each number of steps among the trace information of the combinations obtained in step S3175 (S3180). The similar trace combinations may be determined, for example, that the “method,” “endpoint,” and “payload” in the trace held as the request pattern are the same, and that the difference time from the time listed as “start_time” is within the pre-defined time.

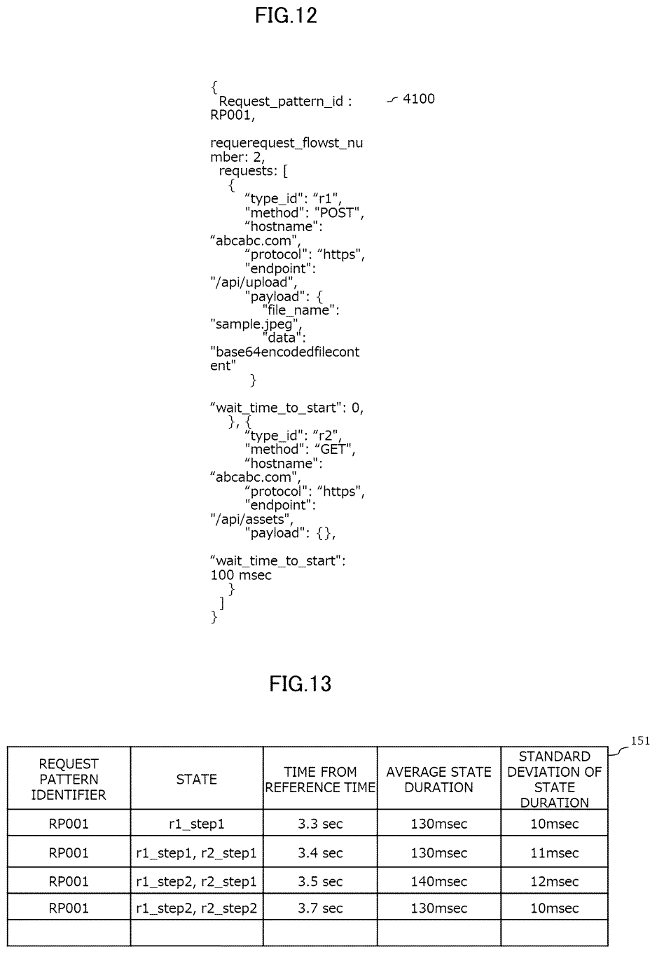

FIG. 12 shows an example of one request pattern in which similar trace combinations are eliminated at each number of steps. In FIG. 12, one type of request (“type_id” is “r1”) is held as trace information with two steps, where “method” is “POST”, “endpoint” is “/api/upload”, and “payload” is “”. Similarly, the second request (“type_id” is “r2”) is held. The request retained in this manner is the request for executing the trace information step shown in FIG. 11. In FIG. 12, the combined trace information obtained in step S3175 (trace information with “2” as the number of steps) contains two types of traces as a result of eliminating the above similar traces, so these are registered as one request pattern (request pattern identifier (id) is “RP001”) is registered.

Returning to FIG. 7, the state reproduction program 110 selects an unselected request pattern among the request patterns obtained in step S3180 and issues a request pattern identifier (S3200). In the example in FIG. 12, the request pattern obtained from the trace information with “2” steps is registered as the request pattern identifier (id) “RP001,” so request pattern identifiers are issued for other request patterns as well.

The state reproduction program 110 obtains the status that can be taken (the state) for the above request patterns in the trace combination information held in step S3180 (S3250). For example, the state reproduction program 110 refers to the original trace information (FIG. 11) for each step included in the request pattern identified by the respective request pattern identifier and reads the state at each step.

The state reproduction program 110 checks whether an entry exists in which the request pattern identifier and step stored in the state table 151 match both the request pattern selected in step S3200 and the state grasped in step S3250, and if not, the entry is recorded as a new entry in the state table (S3255).

FIG. 13 shows an example of the state table 151. The state table 151 is generated by the state reproduction program 110. As shown in FIG. 13, the state table 151 includes a request pattern identifier to identify the request pattern, a state of the request pattern, a time from the reference time which is the time when the pseudo fault request is sent, an average state duration indicating the time that the state continues on average, and a standard deviation of the state duration indicating the time that the state continues are stored in association with each other. The above reference time is the start time of each test defined in the test orchestration. The request pattern identifier is information to be associated with a request pattern 4100. The state of the request pattern identified by the request pattern identifier when the request is made is expressed by the combination of the states of each step in the request. For example, the request pattern shown in FIG. 12 includes two steps, so four states, which are combinations of the states of each of these steps, are registered as the states of the request pattern.

In FIG. 13, for example, the request of the request pattern identified by the request pattern identifier “RP001” takes “3.3sec” to reach the state “r1_step1”, the state average duration of the state is “130 msec”, and the standard deviation of the state duration is “10 msec”. In this example, since there are four combinations of each step in the request pattern shown in FIG. 12, the “time from the reference time,” the “average state duration”, and the “standard deviation of the state duration” are stored for each of those states.

The request state of the request pattern shown in FIG. 12 comprises a combination of the request type identifier in the request pattern 4100 and the steps included in the trace associated with the request. In this example, the request pattern contains two requests, but the state of the request is expressed as “r1_step1” based on the “type_id”: “r1” of the request pattern 4100 and the “step”: 1 written in the trace information 4000 of the corresponding request. Similarly, based on the “type_id”: “r2” of the request pattern 4100 and the “step”: 1 written in the trace information 4000 of the corresponding request, the states of the request are expressed as r1_step1, r2_step1.

The “time from the reference time” is the time since the “trigger time” in the pseudo fault history table 150 shown in FIG. 9, and is obtained, for example, by reading the time (e.g., timestamp) until the state is output, which is described in the trace information (FIG. 10 and FIG. 11). The “average state duration” is calculated by subtracting a “state start time” from a “state end time” of each entry with the same request pattern identifier and state in the state history table 152 at the time of the pseudo fault occurrence described below, and then calculating the average value. The “standard deviation of the state duration” is obtained by calculating the value obtained by subtracting the “state start time” from the “state end time” in each entry with the same request pattern identifier and state in the state history table 152 at the time of the pseudo fault occurrence, and then calculating the standard deviation of the values..

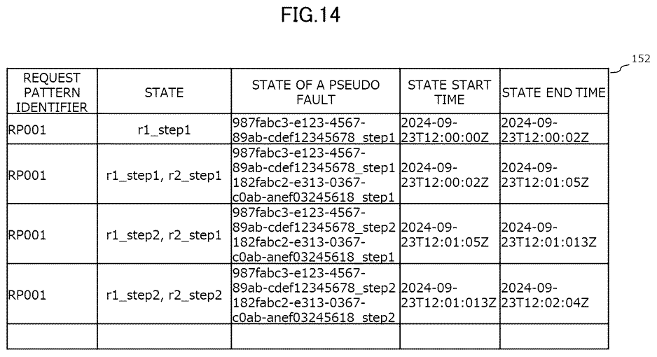

FIG. 14 shows an example of the state history table 152 at the time of a pseudo fault occurrence. The state history table 152 at the time of a pseudo fault occurrence is a table that stores the history of states when a pseudo fault occurred in the past, and is generated by the state reproduction program 110. As shown in FIG. 14, the state history table 152 at the time of pseudo fault occurrence stores a request pattern identifier and a state similar to those in the state table 151 of FIG. 13, a state of a pseudo fault generated in the request pattern identifier and state, a state start time, and an a state end time in association with them.

In FIG. 14, for example, the state of the pseudo fault to be generated in the “r1_step1” state of the request pattern identifier “RP001” is “987fabc3-e123-4567-89ab-cdef12345678_step1”, the start time and the end time of this state are “2024-09-23T12:00:00Z” and “2024-09-23T12:00:02Z”, respectively. The start and the end time of the states can be obtained from the trace information shown in FIG. 10 and FIG. 11. The pseudo fault state “987fabc3-e123-4567-89ab-cdef12345678_step1” is indicates that the trace information is associated with the trace identifier of the trace information (FIG. 10 and FIG. 11) when the pseudo fault was generated.

Returning to FIG. 7, the delay control program 125 refers to the state table 151 and selects an unselected state among the states can be taken (S3300). For example, the delay control program 125 selects the “r1_step1” state with the request pattern identifier “RP001” from the state table 151 shown in FIG. 13.

The delay control program 125 calculates a waiting time to be generated for the state selected in S3300. If the calculated the waiting time is within the range of the above reflection time, the delay control program 125 adopts it as the waiting time for different timing to generate a pseudo fault and sets it to the reverse proxy (S3350). For example, the delay control program 125 reads the time “3.3 sec” from the reference time corresponding to the “r1_step1” state of the request pattern identifier “RP001” and the reflection time calculated in S3100, and if the time “3.3 sec” from the reference time is within the above reflection time range, the reverse proxies (the reverse proxies 700b-1 and 700b-2) are set to wait for the time.

The fault request program 130 requests a pseudo fault, and as explained in S6011 of FIG. 6, the request sending/receiving program 120 sends the request selected in step S3200 to the application server (the other sub-application 500b-2) where the fault occurred as the pseudo fault request (S3400).

The fault request program 130 requests the monitoring manager 200 to obtain the occurrence time of the pseudo fault requested in step S3400 (S3410). Since the occurrence time of the pseudo fault is recorded in the traces, metrics, and logs of the monitoring manager 200, the above occurrence time can be obtained by searching these information including the time when the pseudo fault request was sent in step S3400 (e.g., traces and logs within a predetermined time from the time when the pseudo fault request was sent).

The fault request program 130 stores the fault information corresponding to the occurrence time obtained in step S3410 as a new entry in the pseudo fault history table 150 shown in FIG. 9 (S3425). For example, for each entry of the fault identifier, the fault type, and the fault location in the pseudo fault history table 150 shown in FIG. 9, the fault request program 130 stores the same fault identifier selected from the fault history table 5000a in step S3000, the fault type corresponding to the fault identifier and the fault location corresponding to the fault identifier. The fault request program 130 stores the time when the pseudo fault request is sent in step S3400 as the trigger time, and stores the time obtained in step S3410 as the fault occurrence time. Furthermore, the fault request program 130 stores the value obtained by subtracting the above trigger time from the above fault occurrence time as the time until the occurrence.

Next, the fault request program 130 obtains the trace information of the request sent in step S3400 from the monitoring manager 200 and stores it as a new entry in the state history table 152 at the time of the pseudo fault occurrence shown in FIG. 14 (S3430).

The fault request program 130 updates the time from the reference time, the average state duration, and the standard deviation of the state duration for entries (entries recorded in S3255) whose request pattern identifier and state in the state table 151 match both the request pattern grasped in step S3200 and the state grasped in step S3250 (S3440).

The fault request program 130 then determines whether the fault has been reproduced or not (S3450). Whether or not the fault has been reproduced can be determined by whether or not the same logs, traces, and metrics as those of the production environment 1100 are output.

If the fault request program 130 determines that the fault has not been reproduced (S3450; No), it determines whether all states have been selected (S3460). If the fault request program 130 determines that the fault has been reproduced (S3450; Yes), the process ends. If the fault request program 130 determines that all states have not been selected (S3460; No), it returns to S3300, selects another unselected state, and repeats the process thereafter.

On the other hand, if the fault request program 130 determines that all states have been selected (S3460; Yes), it determines whether all requests have been selected (S3470). If the fault request program 130 determines that all requests have not been selected (S3470; No), it selects another unselected request pattern and repeats the process thereafter.

If the fault request program 130 determines that all requests have been selected (S3470; Yes), it proceeds to step S3480. In step S3480, the fault is not reproduced in step S3450. Therefore, the fault request program 130 determines that a sampling rate monitored by the monitoring manager 200 for the production environment 1100 may be insufficient to meet the predetermined criteria, and requests to increase, for example, a higher sampling rate for traces, metrics, or both, to the monitoring manager 200 (S3480). In accordance with the request, the monitoring manager 200 sets the sampling rate of the trace, the metrics, or both to be higher than before. In S3480, the sampling rate of the trace, the metrics, or both is exemplified, but the sampling rate of the metrics may also be set to be higher than before. When the process of step S3480 ends, the process shown in FIGS. 7A and 7B ends (S3500).

As explained above, according to this system, as described in FIG. 6, S3350, etc. of FIG. 7A, a fault timing control system (e.g., the applicable system 1) including a test execution environment (e.g., the verification environment 1000), which is executed by a computer including a processor and a memory, for performing a test that simulates a fault occurred in a production environment (e.g., the production environment 1100) of a system, the computer in the test execution environment (e.g., the test execution system 100) reads a state indicating a status or a condition of the system from trace information (e.g., FIGS. 10 and 11) at the time of a fault occurrence, and calculates a waiting time for differently timing a pseudo fault according to the read state, generates the pseudo fault based on a send time of a request time for generating the pseudo fault and the calculated waiting time. This makes it possible to cause the pseudo fault at the appropriate timing and the state and reproduce the fault.

In addition, as explained in the loop of S3300-S3460 in FIG. 7A, etc., the computer in the test execution environment reproduces a fault occurred in the production environment by repeatedly generating the pseudo fault by calculating the waiting time after change of the state while changing the state that has been read. This will improve the accuracy of reproducing fault.

As explained in S3125, etc. in FIG. 7A, the computer in the test execution environment obtains the trace information whose trace start time is earlier than the time when the fault occurred and whose trace end time is later than the time when the fault occurred, calculates the waiting time according to the state of the obtained trace information. This makes it possible to narrow down the trace information to be used to reproduce the fault and to reproduce the fault efficiently.

As explained in S3150, etc. in FIG. 7A, the computer in the test execution environment selects, among the obtained trace information, the trace that contains a location of the fault that occurred in the production environment of the system. This ensures that any faults that occur in the production environment can be reproduced.

As explained in S3350, etc. in FIG. 7A, the computer in the test execution environment adopts as the waiting time when the waiting time is within the range of a reflection time, which is the time from the sending time of the request to the time when the pseudo fault occurred. This allows the time from the sending time of the request to the time when the pseudo fault occurred to be set as the waiting time, and after the waiting time has elapsed, subsequent processing can be executed to continue the test. For example, in the example in FIG. 13, there are four states for one request pattern, so the waiting time can be set for each state and the test can be executed.

As explained in S3480, etc. in FIG. 7B, the computer in the test execution environment increases the sampling rate of the trace information than before if the fault cannot be simulated. This can increase the probability of the pseudo fault occurrence.

The invention is not limited to the embodiment described above, and in the implementation stage, the constituents can be modified and embodied within a range not departing from the gist thereof, or a plurality of constituents disclosed in the embodiment described above can be implemented in a suitable combination.

What is claimed is:

1. A fault timing control system including a test execution environment, which is executed by a computer including a processor and a memory, for performing a test that simulates a fault occurred in a production environment of a system,
the computer in the test execution environment
reads a state indicating a status or a condition of the system from trace information at the time of a fault occurrence, and calculates a waiting time for differently timing a pseudo fault according to the read state,
generates the pseudo fault based on a send time of a request time for generating the pseudo fault and the calculated waiting time.

2. The fault timing control system according to claim 1,
wherein the computer in the test execution environment
reproduces a fault occurred in the production environment by repeatedly generating the pseudo fault by calculating the waiting time after change of the state while changing the state that has been read.

3. The fault timing control system according to claim 1,
wherein the computer in the test execution environment
obtains the trace information whose trace start time is earlier than the time when the fault occurred and whose trace end time is later than the time when the fault occurred,
calculates the waiting time according to the state of the obtained trace information.

4. The fault timing control system according to claim 3,
wherein the computer in the test execution environment
selects, among the obtained trace information, the trace that contains a location of the fault that occurred in the production environment of the system.

5. The fault timing control system according to claim 1,
wherein the computer in the test execution environment
adopts as the waiting time when the waiting time is within the range of a reflection time, which is the time from the sending time of the request to the time when the pseudo fault occurred.

6. The fault timing control system according to claim 1,
wherein the computer in the test execution environment
increases a sampling rate of the trace information than before if the fault cannot be simulated.

7. A fault timing control method for executing by a computer, including a test execution environment in which a test is performed to simulate a fault occurred in a production environment of a system,
reading a state indicating a status or a condition of the system from trace information at the time of a fault occurrence, and calculates a waiting time for differently timing a pseudo fault according to the read state,
generating the pseudo fault based on a send time of a request time for generating the pseudo fault and the calculated waiting time.
